(19) United States
(12) Patent Application Publication
(10) Pub. No.: US 2014/0204873 A1
(43) Pub. Date: Jul. 24, 2014

(54) Wireless Device Mirroring with Auto Disconnect

(71) Applicant: Panasonic Corporation of North America, Secaucus, NJ (US)

(72) Inventors: Jean-Claude Junqua, Saratoga, CA (US); Luis Alfonso Hernández-Gómez, Madrid (ES); Martín Lorente-Ortillés, Madrid (ES); Eduardo López-Gonzalo, Madrid (ES); Daniel Tapias-Merino, Madrid (ES)

(73) Assignee: Panasonic Corporation of North America, Secaucus, NJ (US)

(21) Appl. No.: 14/219,612

(22) Filed: Mar. 19, 2014

Related U.S. Application Data
(63) Continuation-in-part of application No. 14/071,691, filed on Nov. 5, 2013.
Application No. 14/071,691 is a continuation-in-part of application No. 14/070,769, filed on Nov. 4, 2013.
(60) Provisional application No. 61/723,652, filed on Nov. 7, 2012.
(60) Provisional application No. 61/723,652, filed on Nov. 7, 2012.

(51) Int. Cl. H04W 76/06

(52) U.S. Cl. CPC H04W 76/06
USPC 370/329

(57) ABSTRACT

A wireless device participates in a mirroring session with an external device such as a display device. A radio signal monitoring circuit compares instantaneous wireless signal strength against a dynamically generated set of thresholds and initiates action to terminate the mirroring session when the mobile device physically moves from the initial location at which the mirroring session was established.

### CROSS-REFERENCE TO RELATED APPLICATIONS

This application is a continuation-in-part of U.S. patent application Ser. No. 14/071,691, filed Nov. 5, 2013, and U.S. patent application No. 14/070,769, filed Nov. 4, 2013, both of which claim the benefit of U.S. Provisional Application No. 61/723,652, filed Nov. 7, 2012. The entire disclosure of each of the above applications is incorporated herein by reference.

### FIELD

The present disclosure relates generally to mobile wireless devices and how those devices may engage in a mirroring session with an external device, such as a display device. More particularly, the disclosure relates to techniques to initiate action to terminate the mirroring session when the mobile wireless device moves.

### BACKGROUND

This section provides background information related to the present disclosure which is not necessarily prior art.

Mobile devices, such as laptop computers, smartphones, tablet computers, personal digital assistants and communicating wearable devices, are typically designed to provide certain functionality that is geared for use by the individual user of that device. Many mobile devices include a display screen, for example, on which an application (App) running on the mobile device supplies visual information to the user.

There are times, however, when the user of a mobile device may want to share the displayed information with others. This might be done, for example, by connecting the mobile device to a conference room display or projector, so that a group of people can simultaneously view the content. If the mobile device has wireless communication capability, connection to the display or projector can be accomplished wirelessly. Such wireless connectivity is typically effected by making a hardwired (cabled) connection between the display or projector and a gateway device that in turn communicates wirelessly with the mobile device.

### SUMMARY

This section provides a general summary of the disclosure, and is not a comprehensive disclosure of its full scope or all of its features.

According to one aspect, a wireless device mirroring apparatus provides support for connecting a mobile device to a display device. The arrangement includes a wireless access point device having a port for attaching to a display device. The wireless access point device has a radio to support communication with a mobile device. The wireless access point device includes a processor programmed to establish a mirroring session between the mobile device and the display device during which session the processor communicates data received from the mobile device to the display device. A radio signal monitoring circuit configured to monitor radio communications of the mobile device initiates action to terminate the mirroring session when the mobile device physically moves away from the wireless access point device. The radio signal monitoring circuit may be deployed, for example, in the mobile device.

According to another aspect, a wireless device mirroring apparatus for connecting a mobile device to a display device employs a processor disposed within the mobile device and programmed to establish a mirroring session with the display device during which session the processor communicates data received from the mobile device to the display device. The apparatus further includes a radio signal monitoring circuit disposed within the mobile device and configured to monitor radio communications of the mobile device and to initiate action to terminate the mirroring session when the mobile device physically moves away from the display device.

In yet another aspect, a method is provided for controlling a mirroring session between a mobile device and a peripheral device. The method involves using a radio within the mobile device to collect radio signal strength data associated with at least one radio source over a first sampling interval and storing that radio signal strength data in non-transitory memory associated with a processor. The processor is then used to compute from the stored radio signal strength data a difference matrix that compares and catalogs radio signal strength data at different times within the first sampling interval and stores the difference matrix in the non-transitory memory. The processor computes and stores at least one threshold level based on data cataloged in the difference matrix. Then, the radio is used to collect additional radio signal strength data associated with the at least one radio source over a second sampling interval later than the first sampling interval. The processor then compares the additional radio signal strength data with the at least one threshold level and issues a location-change detection signal if the additional radio signal data crosses the at least one threshold level. The processor initiates action to terminate the mirroring session in response to the location-change detection signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of an exemplary office building floor, showing a typical environment in which the wireless device mirroring system may be deployed;

FIG. 2 is a diagrammatic view of various mobile devices involved in a mirroring session that is mediated using the auto disconnect capability, and also showing the hardware configuration of an exemplary mobile device;

FIGS. 3a and 3b depict how the processor of a participating device is programmed to effect one embodiment of the auto disconnect capability;

FIG. 4 is a graph depicting the initialization, stabilization and threshold phases, illustrating an exemplary movement detection; and

FIG. 4a is an enlargement of a portion of FIG. 4, showing details of detection in greater magnification.

Corresponding reference numerals indicate corresponding parts throughout the several views of the drawings.

### DETAILED DESCRIPTION

Example embodiments will now be described more fully with reference to the accompanying drawings.

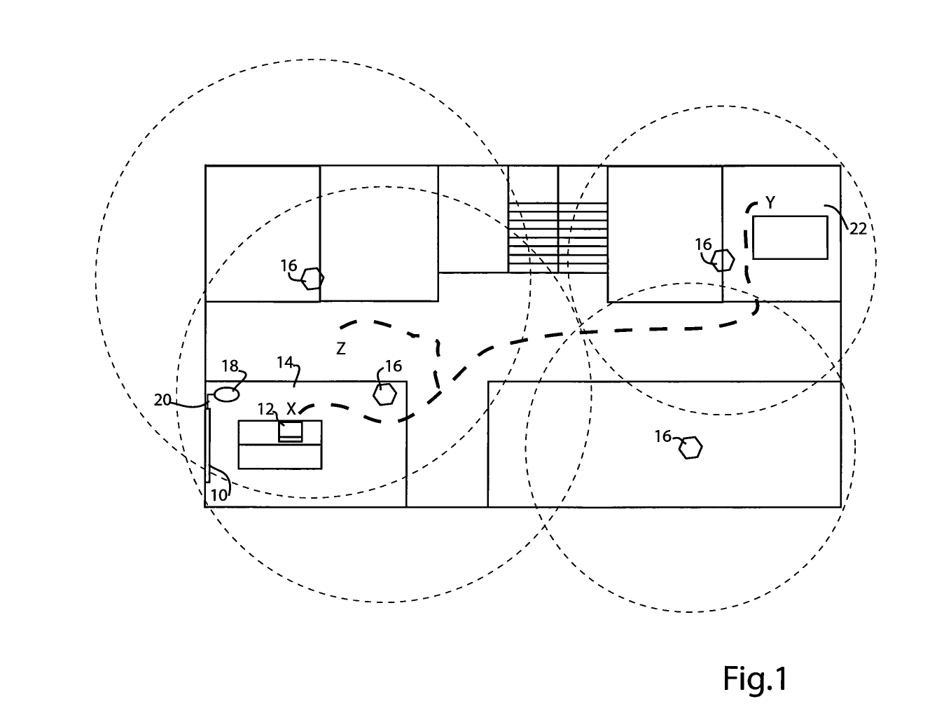

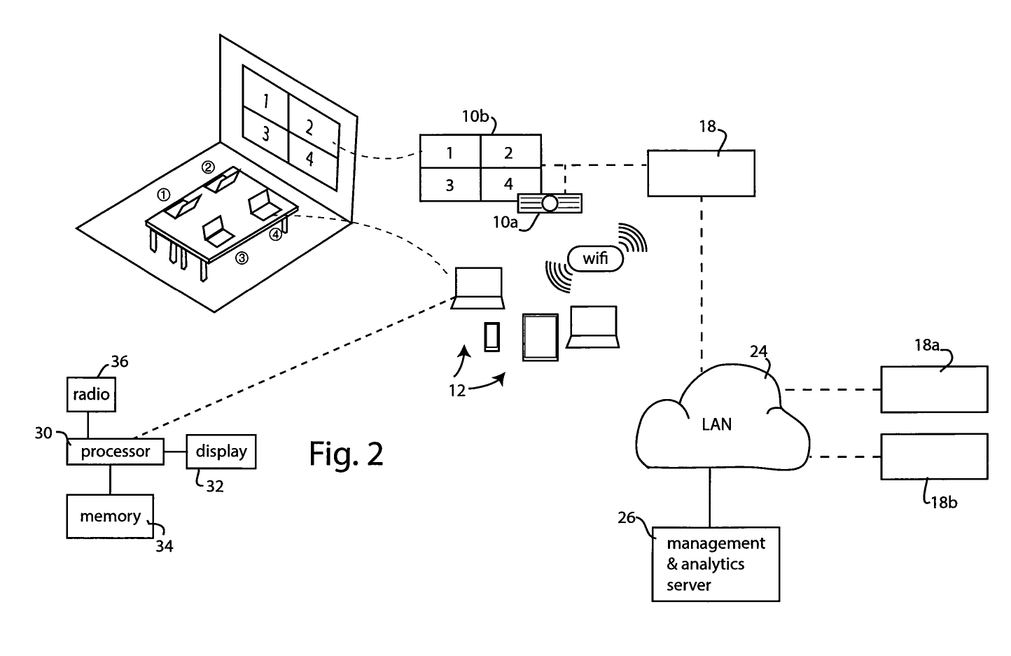

Referring to FIG. 1, an exemplary wireless device mirroring use case is shown. For purposes of illustrating the principles of the device mirroring and auto disconnect features, a display device 10 in the form of a wall-mounted display panel has been illustrated in FIG. 1. Other aspects of this and other mirroring use cases are shown in FIG. 2. In FIG. 2, a projector-based display device 10a and projection screen 10b have been illustrated. It will be appreciated that the principles of the disclosure apply to a variety of other types of display devices, including without limitation, digital and analog projectors, computer monitors, televisions, and the like. In addition, the techniques described herein may be extended to work with other types of devices that lend themselves to being captured and utilized by a mobile device. In this regard, any mobile device 12, such as a laptop computer, tablet computer, smartphone, personal digital assistant (PDA) or wearable communicating device may be used.

### Mirroring and Sharing

For purposes of illustrating the auto disconnect concept, a laptop computer has been illustrated as the mobile device 12 in FIG. 1. In FIG. 2, an assortment of different mobile devices has been illustrated at 12. The mirroring technology has the ability to work with a variety of different devices and different types of devices concurrently. In other words, it is not necessary that all devices participating in a shared mirroring session be of the same type (e.g., laptop computers). A laptop computer and a mobile phone could share a mirroring session, for example.

FIG. 2 shows an example where four laptop computers (this could be a mixture of different types of devices) share separate quadrants of the display device. Those four quadrants have been identified by numerals [1, 2, 3, 4]. The devices each communicate wirelessly, such as via WiFi to a local area network (LAN) 24 to which is connected an access point device 18, which is also coupled to the display device, such as projector 10a. The access point device 18 mediates the shared mirroring session, assigning the display outputs of the participating mobile devices 12 to respective quadrants of the screen, as illustrated. Of course, four quadrants or screen regions is just one possible layout configuration. In general, any number of screen regions can be employed, and screen regions may fully or partially overlap, depending on the requirements of the users giving the presentation.

For more information on how mirroring may be accomplished to permit sharing of a single remote device, such as a display device, with plural mobile devices concurrently, reference may be made to U.S. patent application Ser. No. 14/071,691, filed Nov. 5, 2013, entitled “SmartLight Interaction System,” the disclosure and drawings of which are hereby incorporated by reference. Such wireless mirroring can entail capturing and sending the entire contents of the screen of the mobile device to the display device. Alternatively, wireless mirroring can entail capturing only a portion of the contents of the screen of the mobile device and sending that portion to the display device. In this regard, the portion of content to be mirrored could be either associated with a predetermined window, region or application running on the mobile device, or a region selected by user input. Capture of the screen content of the mobile device, in either case, is carried out by software running on the mobile device.

As illustrated, the local area network 24 can include other access point devices 18a, 18b, which may be connected to other devices for capture during a mirroring session, or which may merely serve as WiFi access points to extend the local area network to other regions of the building floor plan, as shown in FIG. 1. If desired, a management & analytics server 26 may be attached to the local area network, for conducting analytic analysis upon data collected by the devices during the mirroring session. Such data may include radio signal strength fingerprint data, as will be described below. The local area network may also be connected to the Internet, so that devices participating in mirroring sessions can access content stored on remote servers via the Internet.

Although the form factor of the various mobile devices may differ, generally all mobile devices include at least one processor 30, with some form of display 32 attached. The processor executes instructions stored in its associated memory 34, which functions as a non-transitory computer-readable storage medium. In this regard, it will be understood that memory 34 can embody a variety of different technologies, including dynamic random access memory, static random access memory, flash memory, and other comparable devices that are capable of storing executable instructions. The mobile device also includes at least one radio 36, such radio being used here to participate in wireless communication with the local area network. Thus radio 36 may comprise a WiFi transceiver circuit, a cellular telephone transceiver circuit or other forms of wireless communication devices.

In the illustrated use case depicted in FIG. 1, it is assumed that the person controlling mobile device 12 is initially located in conference room 14 as at position X. The entire floor of the office building, of which conference room 14 is a part, is covered by wireless local area network connectivity by means of one or more WiFi access points or stations [STA] 16. Each station 16 transmits and receives radio signals over a range depicted by dotted-line circles surrounding each station 16. Thus, as illustrated, conference room 14 receives WiFi coverage from two stations 16 that are most closely proximate to the conference room.

Conference room 14 also has situated therein a wireless access point device 18 that is coupled by suitable physical connection, such as HDMI cable 20, to the display device. Access point device 18 is also coupled to the local area network to allow devices communicating over the local area network to communicate with access point device 18. The user initiates a mirroring session whereby the mobile device wirelessly communicates with the access point device 18. While this mirroring session is active, the mobile device is able to push content to the display device, effectively mirroring its local display onto the display device 10. Thus people in the room can see what is on the display of the mobile device itself.

For purposes of illustration here, the access point device 18 has been differentiated from the WiFi stations 16. It is, however, possible to incorporate the mirroring functionality of access point device 18 into one or more of the WiFi stations 16.

If desired, the executable instructions performed by the processor of the mobile device to initiate, monitor and terminate a mirroring session may already be resident in the memory of the mobile device or they may be downloaded to the mobile device from access point device 18. In a preferred embodiment, the mobile device communicates with access point device 18 while running conventional browser software of the type normally used to access web pages on the Internet. The user obtains the URL and login information from suitable signage in the conference room where the display device is located. By logging onto that URL and authenticating with the appropriate login information, any executable program code needed to initiate, monitor and terminate the mirroring session is provided as a download via that web page. For more information on how such downloading may be accomplished, reference may be made to U.S. patent application Ser. No. 14/071,691, filed Nov. 5, 2013, entitled “SmartLight Interaction System,” the disclosure and drawings of which are hereby incorporated by reference.

As previously explained, the access point device 18 is configured to support mirroring by more than one mobile device at a time. Thus, two or more users could, using their respective mobile devices, concurrently capture display device 10 for a mirroring session. The access point device 18 mediates sharing of the display device by either partitioning the display device into different regions on the screen, giving each user solitary control over one region, or in a layered fashion where content from plural mobile devices are overlaid onto one another.

The ability to share a display device among multiple users concurrently is not a feature found on the typical display or projector. However, even when only one user has captured a mirroring session, the ability to connect to a display device wirelessly is very empowering. Many have experienced the inconvenience of giving a slide presentation to an audience in a conference room where the presenter's laptop must first be physically connected by cable to the display device. Rarely are the cables long enough, so the presenter is often forced to position himself or herself very near the display device. Often cable adaptors are required, as the display device technology may be from a different era than the presenter's laptop. When two or more persons wish to present using such conventional equipment, a game of musical chairs ensues, where each presenter must successively take position near the display. Sometimes this also entails much plugging and unplugging of different computers, accompanied by a momentary loss of display signal and the need to reboot the display device.

Explanation of the Problem Arising when Device Movement Occurs

The wireless mirroring capability of the technology described here solves the aforementioned problems; however, it introduces a new problem. Referring to FIG. 1, if the user, at position X, initiates a mirroring session and then walks to office 22 at location Y, while carrying his or her mobile device 12, the mirroring session may very well remain live. This is because the wireless access point device 18 is connected as a node on the wireless local area network to which the stations 16 are attached. Thus, when the user moves throughout the floor of the building, his or her mobile device remains in communication with access point 18 and thus remains in communication with the captured display 10. This leads to a potentially embarrassing situation where the user, now gone from the conference room 14, continues to push content to the display device in the conference room. The mirroring functionality essentially captures what is shown on the user's display device, regardless of where the user is, and provides that content to the display device 10. If the user walks to office 22 and uses the mobile device to check his or her private email, for example, those email messages would be visible to everyone in conference room 14.

The auto disconnect technology of this disclosure addresses this potentially embarrassing problem. It does so by monitoring signal strength and optionally other parameters of the wireless local area network and using changes in those signal levels to detect when the mobile device has physically moved away from the wireless access point device and display device to which it is attached.

Recognize that the typical office building floor plan deploys multiple WiFi access points or stations at strategic locations throughout the building. Thus, monitoring the radio signal strength level is by no means a simple manner of monitoring radio signals from a single station. For example, if the user in FIG. 1 moves from location X to location Z, the radio signal strength may actually increase rather than fall off. Thus, the auto disconnect technology of this disclosure uses a more sophisticated technique that collects signal strength fingerprint data associated with each access point station and then uses this fingerprint data to develop an historical fingerprint record against which live fingerprint data are compared.

In addition to topological signal strength variation, attributable to where the access point devices are positioned in space, the signal strength fingerprint data also exhibit variability in the time domain due to fluctuations in signal strength and noise. Such signal strength fluctuation occurs quite unpredictably due to signal interference from other networks or from other mobile devices as they move into and out of range. Adding to this fluctuation are intermittent noise sources such as microwave ovens, commutated motors and some types of electrical lighting circuits. The present technology is designed to handle these issues by utilizing a signal processing algorithm that is performed by a processor, such as the processor within the mobile device, to monitor radio signal strength conditions and detect when physical movement of the mobile device is algorithmically recognized to have occurred within a predetermined degree of confidence.

### Detailed Description of Algorithm

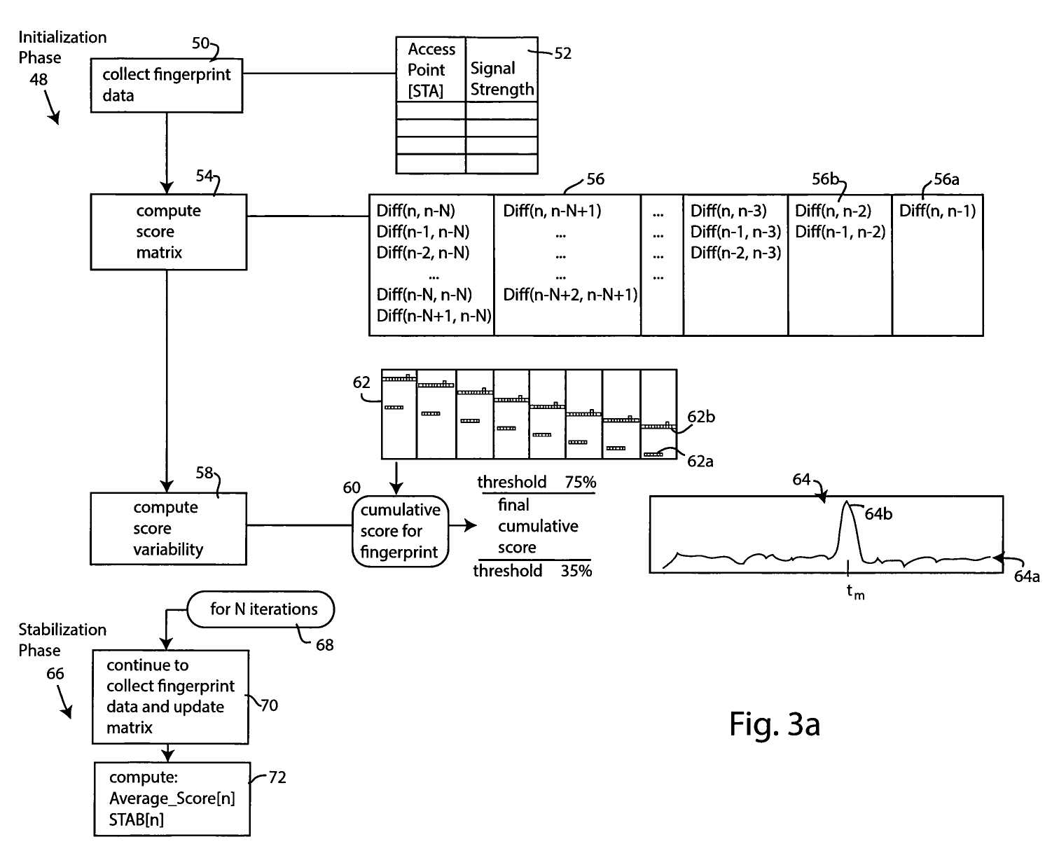

Referring now to FIGS. 3a and 3b, the algorithm executed by processor 30 to detect when the mobile device has physically moved will now be described. As depicted, the algorithm involves three phases, an initialization phase 48, a stabilization phase 66 and a thresholding phase 84. The initializing phase begins with collecting fingerprint data as at 50. To do this, the processor reads signal strength data obtained by radio 36 and populates those readings into a data store 52 stored in memory 34. The signal strength data store 52 is configured in memory to store the access point or station identifier together with each signal strength rearing as illustrated at 52. If desired, a timestamp may also be generated and stored in association with each signal strength reading. The signal strength readings are taken periodically at fixed time intervals. For example, the fingerprint data may be collected at 50 to obtain fingerprints every 1.5 milliseconds. During the initialization phase, a predetermined number of fingerprints are collected and stored. For example, 30 fingerprints may be collected and stored in this fashion.

After collecting a block of fingerprint data, stored at 52, the processor then operates on this stored data to compute a score matrix, as at 54. The algorithm to computing the score matrix is shown at 56. Essentially, the score matrix 56 data structure is allocated in memory 34 (FIG. 2) and mean square signal strength deviation (MSSSD) values are computed and populated into that data structure to define matrix 56. Matrix 56 thus stores the difference of signal strength on common access points measured in different discrete instances of time. In matrix 56, N is the number of samples collected and stored in data structure 52. For example, N=30 represents one suitable quantity of data to capture during the initialization phase. Thus, at 56a in matrix 56, the difference between a current reading (n) and the immediately preceding reading (n−1) are computed and stored. At 56b, the difference between the current reading (n) and the reading two samples before (n−2) are computed and stored, and so forth.

When the entire matrix is computed and populated in this fashion, the MSSSD values provide a temporal view of how the difference scores evolve over successive intervals of sampling time. This evolution has been shown graphically at 62 for an exemplary case where non-zero difference values appear as fingerprint patterns that can be seen to evolve over successive intervals of time. In the depiction at 62, two exemplary difference regions labeled 62a and 62b have been illustrated. These illustrated regions correspond to matrix values where the difference between successive samples is substantially above zero. Such regions correspond to evidence that the mobile device has moved to a place having a different radio signal signature. Because the data for successive columns in the matrix compare the current signal strength value n with successively older signal strength readings, the regions such as 62a and 62b appear to evolve in a stair step-like fashion from one column to the next, as illustrated.

While a graphical representation as depicted at 62 provides useful information, which can be enhanced by using different colors to represent the degree of difference reflected in matrix 56, the present algorithm computes a numerical score variability as at 58 so that the matrix data can be more effectively used. This is accomplished by computing a cumulative score for each fingerprint as at 60. The cumulative score is computed as the summation of all the elements of the scores of the matrix according to equation 1.

ccc_{—}ccccc(c)=Σ_{c=0}^{c-1}Σ_{c=c}^{c-1}cccc(c−c,c−c−1) 1

To further improve the cumulative score, the algorithm performed by processor 30 (FIG. 1) applies upper and lower thresholds whereby values below a predetermined low threshold (e.g., 35) and values above a predetermined high threshold (e.g., 75) are discarded during the cumulative score computation. This has the effect of removing outlier data and filtering out background noise. The cumulative score computed in this fashion can be graphically represented as illustrated at 64. As graphically illustrated, one can see that the cumulative score (for this example) generally remains at a base level 64a, except for a peak at 64b. This peak corresponds to movement of the mobile device to a different radio signal environment at time tₘ.

While the initialization phase 48 populates the matrix 56 from which cumulative score data can be computed at 58, the presently preferred algorithm does not rely on the cumulative score so computed during this initialization phase. This is because when the system is first activated and fingerprint data collected, it cannot be known whether the mobile device was moving at the time of initialization, nor is it known whether there happens to be ongoing signal interference and noise during that initialization phase.

To address this, the processor 30 carries out a stabilization phase algorithm 66 which iteratively performs for a predetermined number of iterations, as at 68, the process of continuing to collect fingerprint data and update matrix 56, as at step 70. During the stabilization phase, the processor computes the average score (Average_Score[n]) which represents the updated average cumulative score. The processor also computes the standard deviation of the average cumulated score (STAB[n]). This is illustrated at 72. The average score and standard deviation may then be monitored by the processor to determine whether the data being collected has achieved a stable condition where the mobile device is not in motion and there are no significant interfering radio signals or background noise. This stabilization phase algorithm can be repeated until it is determined that conditions have stabilized, if necessary.

Referring next to FIG. 3b, the threshold phase 74 will now be described. Processor 30 uses the average score and standard deviation scores discussed in connection with the stabilization phase to compute a set of dynamic thresholds as depicted at 76. These thresholds include a non-activity threshold or background threshold 78 and at least one activity threshold. In FIG. 3b, two activity thresholds, a lower threshold 80 and a higher threshold 82, have been depicted. These respective thresholds are calculated using Equations 2-4.

Eq. 2:

Threshold_Bck[n]=Average_Score[n]+STAB[n]*SCALE_STD. 2

Where: Average_Score[n] is the updated average cumulated score.
STAB[n] is the standard deviation of the average cumulated score.
SCALE _STD is a variable set to 4 in the exemplary implementation and

5,000≦STAB[n]* SCA; E+STD≦10,000.

Eq. 3:

Threshold_Bck[n]=Average_Score[n]+STAB[n]*SCALE_STD*ActBck_FACT 3

Where: ActBck_FACT is a scale factor set to 1.5 in the current implementation, and

10,000≦STAB[n]* SCA; E+STD*ActBci_FACT≦20,000.

Eq. 4:

Threshold_Bck[n]=Average_Score[n]+STAB[n]*SCALE_STD*ActBck_FACTa 4

Where: ActBck_FACTa is set greater than ActBck_FACT.

Note that each of these thresholds are computed by adding the average score for a sample with the standard deviation for that sample after multiplying the standard deviation by scale factor SCALE_STD. The respective lower and higher activity threshold scores are both referenced to the background threshold but include an additional multiplier factor ActBck_FACT. This additional scale factor may be set to a value on the order of 1.5 (or somewhat higher for the activity threshold 82). This activity threshold scaling factor serves to define a dynamic threshold that is a predetermined percentage higher than the background threshold.

Processor 30 uses the dynamically computed thresholds to compare against the cumulative score obtained during each sampling interval (n). If the cumulative score exceeds an activity threshold for more than a predetermined number (N_samples) of samples consecutively, the processor issues a change detection signal at 88.

The decision process performed by the processor works as follows. Once the decision algorithm starts computing thresholds, the cumulated score (cum_score[n]) is compared with both the non-activity threshold and the activity threshold (or thresholds if multiple activity thresholds are implemented). The decision on a location change is made when the cumulated score peaks over the highest threshold (the activity threshold) for more than N_SAMPLES in a row. In an exemplary implementation, N_SAMPLES is set to 4 (i.e., 6 seconds).

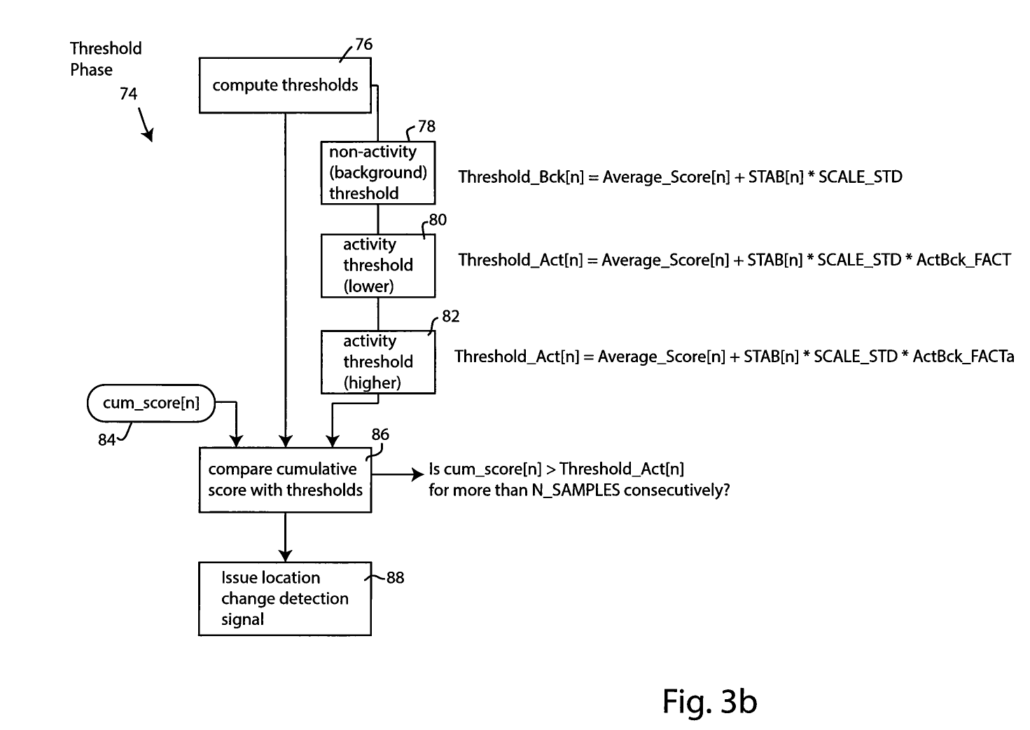

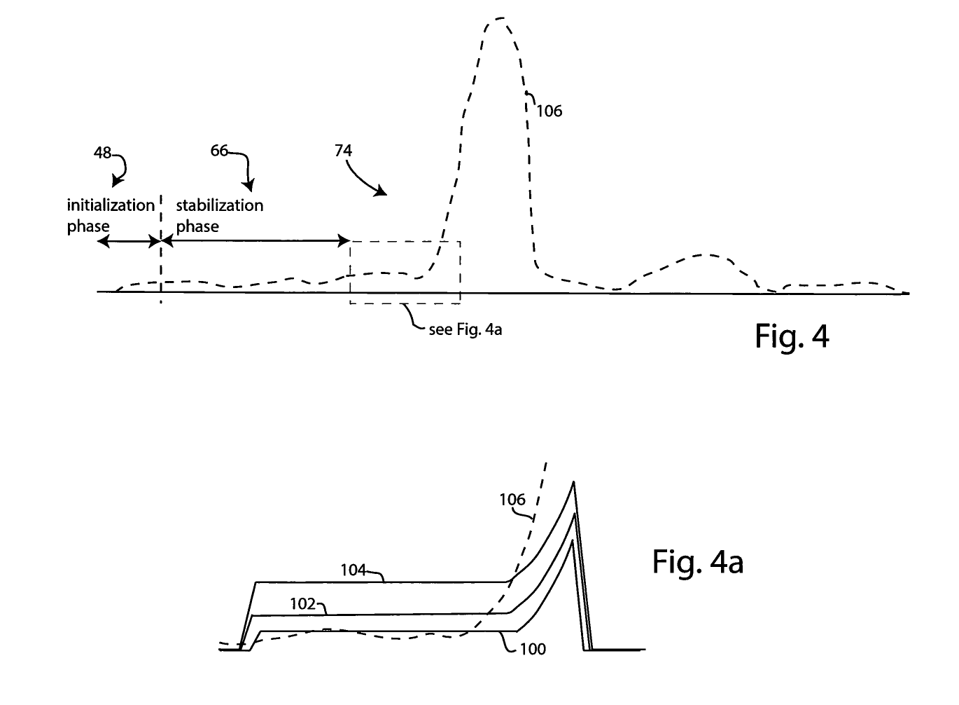

FIG. 4 shows how an exemplary movement detection would appear. FIG. 4 shows the initialization, stabilization and threshold phases. During the initialization phase 48, the cumulated score values are not valid for estimating the thresholds. During the stabilization phase 66, which occurs next, the average cumulated score and its standard deviation is computed. Finally, the threshold phase 74 begins. As can be seen, there is a point where the cumulated score goes over the thresholds and a location change is detected.

FIG. 4a shows an enlargement of a portion of FIG. 4. The line designated 100 is the average cumulated score used to update the two decision thresholds. The line designated 102 is the non-activity decision threshold Threshold_Bck. The line designated 104 is the activity decision threshold Threshold_Act. The dashed line 106 is the instantaneous score.

In one embodiment, if the cumulative score for the predetermined number of samples exceeds the lower activity threshold 80, then the processor provides a message to the user of the mobile device, suggesting that the user may terminate the mirroring session. On the other hand, if the cumulative score for a predetermined number of samples exceeds the higher threshold 82, then the processor automatically terminates the mirroring section without involving the user. In this way, when detected changes may indicate the mobile device user has left the conference room, but that determination is not certain, the device user is given the option to leave the mirroring session intact.

If desired, the processor can present the user with a user interface control setting whereby the lower activity threshold may be adjusted to suit the user's frequently encountered conditions. Thus, for example, if a conference room happens to be located near a kitchen where a microwave oven is intermittently used, the user may wish to set the upper threshold higher, so that operation of the microwave oven does not inadvertently disconnect a mirroring session. The user might also elect to set the lower activity threshold to the setting previously occupied by the upper activity threshold, thereby giving the user control over whether conditions warrant session termination.

If desired, the movement detection algorithm performed by the processor within the mobile device can be performed by processors located in other devices that communicate with the mobile device. Thus radio signal strength readings may be captured by the mobile device and then sent to a server, such as server 26 (FIG. 2) for further processing. Such additional processing may include, for example, computing normalized values of the cumulated scores, to alleviate the need to tune matrix parameters and radio sensing parameters to match particular environments.

In addition, such additional processing (on either the mobile device or the server) may include automatically adapting to the characteristics of different models of mobile devices. This would be done, for example, by obtaining identifying information about the mobile device (e.g., device model number) so that the exact parameters of that device's particular radio equipment can be ascertained and compensated for. In this regard, newer model mobile devices tend to have newer WiFi technology, which generally is more capable of receiving signals from a distance. These newer devices, unless compensation is made, may appear to be in proximity to the mirrored external device, even when they are in fact quite far away. By knowing the characteristics of the particular device, appropriate changes can be made to the way threshold levels are calculated.

Further, additional processing can be performed to automatically adapt to particular environmental conditions. In this regard there is often a marked difference between domestic and office environments, on the one hand, and public places (e.g., shopping centers) on the other. By detecting characteristics in the patterns of these different environments, additional processing may be performed to adapt the detection algorithm, changing threshold values as appropriate to ensure reliable movement detection.

Moreover, while signal strength data has been currently described, other radio signal parameters may also be added to the fingerprint data, if desired. For example, current United States WiFi standards employ two different radio frequencies: 2.4 GHz and 5 GHz. Within these two frequencies the deployed access point stations may operate on different selected channels, and with different bandwidths, WiFi modes (b/g/n, ac, etc.). In addition to the radio signal parameters, each access point station broadcasts a unique BSSID and also typically broadcasts information from which the vendor identification can be ascertained. These data may also be used to get a better “picture” of the WiFi topology through which the mobile device may wander when its owner is moving.

Some or all of these additional data can be a appended to the fingerprint vector and used in applying subsequent pattern recognition techniques to discriminate movement-generated variation in fingerprint from spurious signal fluctuation-generated variation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A wireless device mirroring apparatus for connecting a mobile device to a display device comprising:
a wireless access point device having a port for attaching to the display device, the wireless access point device having a radio to support communication with the mobile device, the wireless access point device having a processor programmed to establish a mirroring session between the mobile device and the display device during which session the processor communicates data received from the mobile device to the display device; and
a radio signal monitoring circuit configured to monitor radio communications of the mobile device and to initiate action to terminate the mirroring session when the mobile device physically moves away from the wireless access point device.

2. The apparatus of claim 1 wherein the processor is programmed to establish said mirroring session in response to a command issued by the mobile device.

3. The apparatus of claim 1 wherein the radio signal monitoring circuit is deployed in the mobile device.

4. The apparatus of claim 1 wherein the wireless access point device includes non-transitory memory storing an executable computer program that when executed by a processor analyzes the radio communications of the mobile device and detects when the mobile device has physically moved away from the wireless access point device.

5. The apparatus of claim 4 wherein the wireless access point device is programmed to transfer the executable computer program to the mobile device to be executed by a processor in the mobile device.

6. The apparatus of claim 1 further comprising a mobile device having a non-transitory memory storing an executable computer program that when executed by a processor in the mobile device analyzes the radio communications of the mobile device and detects when the mobile device has physically moved away from the wireless access point device.

7. The apparatus of claim 1 wherein the radio signal monitoring circuit is configured to analyze radio communications of the mobile device to detect when the mobile device has physically moved, by collecting and storing historical radio signal strength data associated with at least one radio source and comparing a current radio signal strength received by the mobile device to detect if the current radio signal strength is below a predetermined threshold relative to the historical radio signal strength data.

8. The apparatus of claim 7 wherein the radio signal monitoring circuit is configured to initiate collecting and storing historical radio signal strength data in conjunction with establishment of the mirroring session between the mobile device and the display device.

9. The apparatus of claim 1 wherein the radio signal monitoring circuit comprises a transceiver disposed in the mobile device that communicates with a wireless local area network.

10. A method controlling a mirroring session between a mobile device and a peripheral device comprising:
using a radio within the mobile device to collecting radio signal strength data associated with at least one radio source over a first sampling interval and storing said radio signal strength data in non-transitory memory associated with a processor;
using the processor to compute from the stored radio signal strength data a difference matrix that compares and catalogs radio signal strength data at different times within the first sampling interval and store said difference matrix in said non-transitory memory;
using the processor to compute and store at least one threshold level based on data cataloged in said difference matrix;
using said radio to collect additional radio signal strength data associated with said at least one radio source over a second sampling interval later than the first sampling interval;
using the processor to compare the additional radio signal strength data with said at least one threshold level and to issue a location change detection signal if the additional radio signal data crosses said at least one threshold level; and
using the processor to initiate action to terminate the mirroring session in response to the location change detection signal.

11. The method of claim 10 wherein the processor is disposed within the mobile device.

12. The method of claim 10 wherein the processor computes a non-activity threshold level and an activity threshold level, the processor computing the non-activity threshold level as an average of the data cataloged within the difference matrix and the processor computing the activity threshold level by augmenting the non-activity threshold level by a predetermined factor.

13. The method of claim 12 wherein the activity threshold level is augmented by multiplying the non-activity threshold level by a predetermined multiplier.

14. The method of claim 10 further comprising using the processor to partition the difference matrix into plural time slices each defining a radio signal fingerprint.

15. The method of claim 14 further comprising using the processor to compute a cumulative score for each fingerprint.

16. The method of claim 14 further comprising using the processor to compute a threshold-limited cumulative score for each fingerprint by discarding difference matrix data that fall outside predetermined upper and lower limits.

17. The method of claim 10 wherein the processor is disposed within the mobile device and the processor initiates and mediates the mirroring session between the mobile device and the peripheral device.

18. The method of claim 10 wherein the processor is disposed within the mobile device, wherein the peripheral device is a display device and wherein the processor during the mirroring session captures visual content from the mobile device and provides that content to the display device.

19. The method of claim 18 wherein the display device is attached to a wireless access point device and wherein the processor provides content to the display device by controlling said radio to communicate the visual content wirelessly to the wireless access point device which then provides said content to the display device.

20. A wireless device mirroring apparatus for connecting a mobile device to a display device comprising:
a processor disposed within the mobile device and programmed to establish a mirroring session with the display device during which session the processor communicates data received from the mobile device to the display device; and
a radio signal monitoring circuit disposed within the mobile device and configured to monitor radio communications of the mobile device and to initiate action to terminate the mirroring session when the mobile device physically moves away from the display device.
